(19) United States
(12) Patent Application Publication
(10) Pub. No.: US 2020/0063266 A1
(43) Pub. Date: Feb. 27, 2020

(54) METHOD TO DEPOSIT A PRECIOUS METAL FILM

(71) Applicant: THE UNIVERSITY OF HONG KONG, Hong Kong (CN)

(72) Inventors: Kwong Yu Chan, Tuen Mun (HK); Albert Voskanyan, Hong Kong (HK); Chi Ying Vanessa Li, Hong Kong (CN)

(21) Appl. No.: 16/111,127

(22) Filed: Aug. 23, 2018

(51) Int. Cl. C23C 18/44; C23C 18/18

(52) U.S. Cl. CPC C23C 18/44; B01J 37/16; C23C 18/1872

(57) ABSTRACT

A versatile, highly scalable single step method is provided for depositing a metallic Pd film from low temperature combustion of an aqueous solution. By using only palladium nitrate and glycine as precursors, water as a solvent, mirror-bright dense Pd films with high crystallinity and good adhesion can be deposited at 250° C. on different substrates without subsequent annealing. The technique can be used to form a reusable catalytic flask as illustrated by the Suzuki-Miyaura cross-coupling reaction, where the Pd film uniformly covers the inner walls of the flask and eliminates the catalyst separation step.

### FIELD OF THE INVENTION

The present application relates, generally, to depositing a dense, high quality metal thin film and, more particularly, palladium via a one-step aqueous combustion process which can be easily scaled up.

### BACKGROUND OF THE INVENTION

Conventional metal film deposition from aqueous solutions via electrochemical methods is limited to conductive substrates. Electrochemical deposition is vulnerable to hydrogen generation due to the cathodic potential resulting in a brittle film due to hydrogen embrittlement. Electroless disposition via a chemical redox reaction also suffers potential hydrogen embrittlement problems.

More than half the supply of palladium (Pd) in the world is used as catalysts, for conversion of toxic gases from automotive exhausts, and in the electronics industry. [1-5] Due to their high hydrogen storage capacities, Pd films have also been widely used in hydrogen sensing, storage, and purification. [6-9] To fabricate Pd films or coatings, a wide variety of different deposition methods have been employed in the past. Among the vapor deposition techniques, metal-organic chemical vapor deposition (MOCVD), sputtering, pulsed laser deposition (PLD), and atomic layer deposition (ALD) have been successfully employed for growing high-quality crystalline Pd films. [10-15] However, the need for expensive and volatile metal such as organic precursors, the low deposition rates, the need for large vacuum facilities and the need for costly instrumentation make it difficult to use these methods cost-effectively on a large scale. Solution-processed deposition, however, has many advantages including, for example, easy control of the composition ratio, large deposition area, low cost, and roll-to-roll capability.

Despite high demand and usage, the production of Pd films from aqueous solutions via chemical or electrochemical deposition remains a challenging task, primarily due to the severe embrittlement arising from the hydrogen adsorption with subsequent dissolution. [16, 17] Therefore, only brittle films or palladium black deposits with low adhesion can be obtained. Since the hydrogen generation overpotential is very low on the Pd surface, an alternative approach involves electrochemical deposition using non-aqueous solvents, such as ionic liquids (ILs). Unlike aqueous solvents, the wider electro-chemical windows in ILs allow for the prevention of undesirable hydrogen evolution. The text by Endres et al., “Electrodeposition from Ionic Liquids,” John Wiley & Sons: New York, 2008; Ch. 4. reported using copper as a counter electrode in Lewis base ILs (a mixture of 1-butyl-3-methylimidazolium chloride and AlCl₃). Pd deposits were obtained at 100° C. [18] More recently, thick Pd coatings with a thickness of up to 10 μm were successfully electroplated through palladium-containing ILs known as Liquid Metal Salts. [17] The presence of a palladium cation in the IL structure permitted deposition at high current densities. Although ILs solve the problems associated with the hydrogen evolution, they have not yet been used in industrial production due to their high cost. Moreover, their inherent properties such as high viscosity, low specific conductivity, and generation of inorganic impurities during the electrodeposition, make the overall process rather complex. [16]

Solution combustion synthesis (SCS) is an energy and time efficient method for synthesizing oxide powders on a large scale. [19-22] It involves generation of energy by a chemical reaction between a metal nitrate (oxidizer) and a fuel in a homogeneous mixture, which is accompanied by mass and heat transfer. Heating is required only to initiate the ignition, and the reaction becomes self-propagating without additional energy consumption. Generally, for highly exothermic mixtures, a small increase in temperature raises the reaction rate by many orders of magnitude, thus leading to thermal runaway. After ignition, precursors convert into the product within seconds. The product properties are primarily governed by the heat of combustion and gas evolution. These parameters stringently depend on the nature of the fuel and the fuel-to-oxidizer ratio. Depending on the type of the fuel, the maximum generated temperature can be tuned as different fuels have different heat of combustion. At the same time, the amount of gases generated, which also depends on the fuel type, can affect the ultimate porosity. Recently, Mark's group extended SCS to develop a method of low-temperature solution processing of semiconducting metal oxide thin films. This protocol has also been effectively utilized by other research groups to produce high-performance thin film transistors (TFTs) with excellent device performance. [23-30] The exothermic reaction of a metal nitrate with a fuel (acetylacetonate or urea) ignited at 200-300° C. liberates heat, thus converting precursors into oxides. Notably, acetylacetonate was primarily used in film depositions instead of commonly used fuels of glycine, urea, and citric acid in powder SCS. Also, 2-methoxyethanol was used as a solvent instead of water. Due to the high cooling rate of the combustion reaction, the generated heat quickly dissipates, making it possible to deposit films onto thermally sensitive substrates without detrimental impacts. Heat transfer in sub-micrometer films differs from powders and heat is dissipated much faster on films, which possess a high surface-to-volume ratio. [31] Realizing that metal oxide films prepared by SCS show excellent performance in microelectronic devices as a transistor, gate dielectric, or source/drain electrode, this method was quickly extended to other fields including photovoltaics, optoelectronics, and thermoelectric generators. [27, 29, 32, 33] In light of the findings from previous works, the question arises whether the SCS method could be employed for the deposition of metallic films, specifically Pd.

### SUMMARY OF THE INVENTION

The present invention relates to a novel one-step process for the facile, scalable, and aqueous solution-processed deposition of high-quality nanocrystalline Pd thin films through an energy and time efficient aqueous combustion synthesis, thus providing advantages over other wet-chemical methods. The result is a mirror-bright, durable Pd film on substrates including glass and glassy carbon.

Although preparation of various semiconducting metal oxide films has been successfully demonstrated via SCS, this method relates to deposition on a metallic film. By using only palladium nitrate and glycine as precursors, and water as a solvent under atmospheric pressure, mirror-bright dense Pd films with high crystallinity are deposited directly at 250° C. in the air without subsequent annealing. Importantly, water is used as the solvent instead of toxic organic compounds. Hence this method provides a green chemistry route to scalable deposition of nanostructured metallic films. Based on this approach, the direct combustion deposited Pd film on a glassy carbon electrode resulted in excellent catalytic activity for alcohol electrooxidation in an alkaline media without the use of any binder or additive.

The mechanism of Pd film formation according to the present invention involves a complex formed between palladium nitrate and glycine at low temperature. The catalytic properties and stability of these films were successfully tested in alcohol electrooxidation and electrochemical oxygen reduction reaction. This simple procedure has many advantages including a very high deposition rate (>10 cm² min⁻¹) and a relatively low deposition temperature (250° C.), which makes it suitable for large-scale industrial applications.

Further, a novel Pd film coated reusable catalytic flask was engineered by utilizing the unique advantages provided by aqueous combustion synthesis. The Pd film uniformly covers the inner walls of the flask and eliminates the catalyst separation step. The catalytic activity of such a flask was successfully tested for the Suzuki-Miyaura cross-coupling reaction of iodobenzene and phenylboronic acid to yield biphenyl.

### BRIEF DESCRIPTION OF THE DRAWINGS

This patent or application file contains at least one drawing executed in color. Copies of this patent or patent application publication with color drawing(s) will be provided by the Office upon request and payment of the necessary fee.

The foregoing and other objects and advantages of the present invention will become more apparent upon reference to the following detailed description and annexed drawings in which like designations denote like elements in the various views, and wherein:

FIG. 1 is a flow diagram of the metallic Pd film deposition via aqueous combustion synthesis according to the present invention;

FIG. 2A is a cross-sectional SEM image of the Pd film obtained from Pd(NO₃)₂:NH₂CH₂COOH=1:1.2 molar ratio, FIG. 2B is a TEM image (inset: SAED) thereof, FIG. 2C is a top view SEM image thereof, FIG. 2D is a EDS pattern thereof, FIG. 2E is an XRD pattern thereof, and FIG. 2F is an XPS thereof;

FIGS. 3A-3D illustrate DSC curves for Pd(NO₃)₂ (FIG. 3A), NH₂CH₂COOH (FIG. 3B), Pd(NO₃)₂:NH₂CH₂COOH=1:1.2 (FIG. 3C), and Pd(NO₃)₂:NH₂CH₂COOH=1:2, in air (FIG. 3D), respectively. FIGS. 3E-3F illustrate ¹H-NMR spectra of NH₂CH₂COOH (FIG. 3E) and Pd(NO₃)₂:NH₂CH₂COOH=1:2 precursor solution heated at 80° C. (FIG. 3F). FIG. 3G illustrates ESI-MS spectra of Pd(NO₃)₂:NH₂CH₂COOH=1:2 precursor solution heated at 80° C. FIG. 3H illustrates a mass spectroscopy analysis of CO and CO₂ produced from combustion of the Pd(NO₃)₂:NH₂CH₂COOH=1:2 precursor solution;

FIG. 4 illustrates a possible reaction mechanism for Pd formation from a Pd(NO₃)₂—NH₂CH₂COOH mixture;

FIG. 5A is a photograph of a pristine glassy carbon electrode, a Pd coated glassy carbon electrode, a PTFE shroud and a change disk tip, FIG. 5B is a photograph of an assembled electrode, and FIGS. 5C-5F are cycling voltammograms of Pd film in N2 saturated 0.5 M NaOH (FIG. 5C), 0.5 M NaOH+0.5 M ethanol (FIG. 5D), 0.5 M NaOH+0.5 M methanol (FIG. 5E), and 0.5 M NaOH+0.5 M glycerol solutions at 10 mV s⁻¹ (FIG. 5F);

FIGS. 6A and 6B show ORR polarization curves for Pd film obtained in an oxygen-saturated 0.1 M NaOH solution at a scan rate of 10 mV s⁻¹ and different rotation rates from (400 to 2900 rpm) (FIG. 6A), and a Koutecky-Levich plot of I⁻¹ versus ω^{-1/2} at 0.3 V vs RHE (FIG. 6B); and

FIG. 7 is a reusable round-bottomed catalytic flask coated with Pd film.

### DETAILED DESCRIPTION OF ILLUSTRATIVE EXEMPLARY EMBODIMENTS

The present invention relates to the aqueous solution-processed deposition of high quality nanocrystalline Pd thin films through an energy and time efficient aqueous combustion synthesis. As a result, the invention provides advantages over other wet-chemical methods. Although preparation of various semiconducting metal oxide films has been successfully demonstrated via SCS, this invention differs in that relates to a metallic film. By using only palladium nitrate and glycine as precursors, and water as a solvent under atmospheric pressure, mirror-bright dense Pd films with high crystallinity are deposited directly at 250° C. in the air without subsequent annealing. Importantly, water is used as the solvent instead of toxic organic compounds. Hence this method provides a green chemistry route to scalable deposition of nanostructured metallic films. Based on this approach, the direct combustion deposited Pd film on a glassy carbon electrode has shown excellent catalytic activity for alcohol electrooxidation in an alkaline media without the use of any binder or additive. More importantly, for the first time, a Pd film coated reusable catalytic flask has been engineered by utilizing the unique advantages provided by aqueous combustion synthesis. The catalytic activity of such a flask has been tested for the Suzuki-Miyaura cross-coupling reaction of iodobenzene and phenylboronic acid to yield biphenyl.

The first step in carrying out the present invention is the preparation of a precursor solution. All chemicals were purchased commercially (e.g., from Sigma-Aldrich) and were used without further purification. Aqueous palladium precursor solutions were prepared by dissolving 100 mg palladium nitrate (Pd(NO₃)₂.H₂O, 99.9%) and 40 mg glycine (NH₂CH₂COOH, 98.5%) in 20 mL ultrapure water (18.2 M Ω ·cm) to obtain a solution with Pd²⁺ concentration of 0.016 M. Thermal characterization of the precursor solution was carried out by differential scanning calorimetry (DSC). DSC curves were recorded using a DSC Q20 instrument with a heating rate of 10° C. min⁻¹ in air. The gaseous products of combustion were in situ analyzed using a Hiden CatLab microreactor station equipped with a quadrupole mass spectrometer Qic 20. The palladium diglycinate complex formation was analyzed in a D₂O solvent using nuclear magnetic resonance (NMR) (Bruker DRX-400) operating at 400 MHz for ¹H and 100 MHz for ¹³C analysis with chemical shifts relative to tetramethylsilane and also by electrospray-ionization mass spectrometry (ESI-MS).

The next step was the deposition of the film on to substrates and its characterization. Prior to film deposition, all substrates (soda-lime glass, glassy carbon and borosilicate glass) were cleaned by sonication in acetone, toluene, acetone, hot isopropanol, and deionized water in sequence for 30 min, and dried under N₂. To obtain a hydrophilic surface and to remove organic residues. The substrate was then treated with UV/Ozone for 15 min. All solutions were then filtered through 0.45 μm PTFE filter before coating. Thin films were deposited by spin-coating precursor solutions for 30 sec. at different rotating speeds and subsequently heating for 10 min at 250° C. in ambient conditions. Importantly, 250° C. is the minimum temperature needed for pure Pd formation. To deposit 260 nm thick films for analysis, 0.2 mL of precursor solution was drop cast onto the glass substrate (2×2 cm2) and annealed on a hot plate at 250° C. and kept for 10 min in ambient conditions. The SCS deposition process was repeatedly carried out (more than 10 times) with reproducible Pd film properties under same synthesis conditions. The compositions of the as-synthesized films were acquired using powder X-ray diffraction (XRD) with CuKα radiation at 40 kV and 40 mA (D8 Advance, Bruker). The film thickness was determined by cross-sectional scanning electron microscopy (SEM) images (Hitachi S-4800 with an accelerating voltage of 7 kV).

The microstructure and composition of the films were examined by SEM, transmission electron microscopy (TEM) (Phillips Tecnai 20 with an accelerating voltage of 200 kV), and energy dispersion spectroscopy (EDS). For TEM characterization, the film was scratched from the substrate dispersed in water via sonication and was deposited onto a carbon-coated copper grid. X-ray photoelectron spectroscopy (XPS) was performed to determine the surface chemical states on a Kratos Axis Ultra DLD multi-technique system under ultrahigh vacuum (<10⁻⁸ Torr) with a monochromatic AlKα X-ray source. The sample was scanned 4 times. Charging of samples was corrected by setting the binding energy of the adventitious carbon (C 1s) to 284.8 eV.

Next the electrochemical character of the film was determined. All electrochemical measurements were conducted with a BioLogic VMP3 multichannel electrochemical station using rotating disk electrode (RDE) (E5TQ Pine Instrument Company composed of a glassy carbon interchangeable electrode with a 5 mm diameter×4 mm thickness) as a working electrode, a platinum wire counter electrode, and a Hg/HgO (0.5 M NaOH) reference electrode. The pure palladium film with ˜250 nm thickness was directly deposited (mass loading 0.18 mg cm⁻²) on an interchangeable glassy carbon electrode (Pine Research Instrumentation) in accordance with the protocol of the invention. The use of an interchangeable electrode avoids direct heating of the PTFE shroud. No binder or additive was added, and the as-synthesized electrode was used directly. Then, the obtained electrode was inserted back into the PTFE shroud to perform the electrochemical tests.

For electrochemical alcohol oxidation tests, cyclic voltammetry (CV) experiments were conducted at rotating rate of 1500 rpm for the working electrode. Prior to each experiment, N₂ was purged through the electrolyte for 20 min to remove the dissolved oxygen. The electrocatalytic measurements were performed in 0.5 M NaOH+0.5 M alcohol (methanol, ethanol, or glycerol) saturated with nitrogen at room temperature at a scan rate of 10 mV s⁻¹. All recorded potentials were converted relative to the reversible hydrogen electrode (RHE). Oxygen reduction reaction (ORR) was studied in 0.1 M NaOH oxygen saturated solution at a scan rate of 10 mV s⁻¹. The ORR current densities were determined through linear sweep voltammetry from 0.0 to 1.0 V at 10 mV s⁻¹. The disk electrode was rotated at 400 to 2900 rpm.

Next a Suzuki-Miyaura Cross-Coupling Reaction test was performed. Phenyl iodide (1.0 mmol, 204.0 mg), phenylboronic acid (1.2 mmol, 146.3 mg), K₂CO₃ (2.0 mmol, 276.4 mg), EtOH (2.5 mL), and deionized H₂O (2.5 mL) were placed in a 10 mL round-bottomed flask which was coated by palladium (2.5⁻3 mg). The flask was rotated for 3 h at room temperature. After 3 h the liquid was decanted, and diethyl ether was added (5 mL×3) and decanted again. The decanted liquid was transferred to a separation funnel and washed with H₂O (10 mL). The aqueous layer was extracted with diethyl ether (10 mL). The collected organic layer was washed with brine (10 mL) and then dried over MgSO₄. The solvent was removed under reduced pressure, and the resulting residue was purified by silica gel column chromatography. The Pd coated flask was washed with deionized H₂O (5 mL×2) and EtOH (5 mL×2), and it was used directly in the next cycle. The residual product was verified by ¹H and ¹³C NMR analysis.

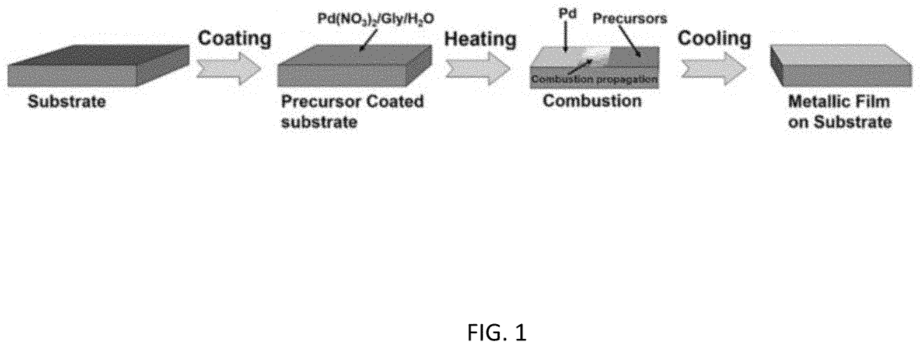

Finally, the properties of deposited Pd film are considered. The deposition of Pd film on a glass substrate by aqueous combustion synthesis is shown schematically in FIG. 1. First, the substrate was uniformly coated with an aqueous mixture of Pd(NO₃)₂ and glycine (NH₂CH₂COOH). Palladium nitrate is the oxidant as well as the Pd precursor, whereas NH₂CH₂COOH is used as a fuel. To deposit a metallic film, fuel rich conditions are chosen with Pd(NO₃)₂:NH₂CH₂COOH=1:1.2 molar ratio. A lower ratio will lead to fuel lean conditions and the formation of a PdO film.

During moderate heating and upon water evaporation, a gel is formed which ignites with heat generation. A mirror-bright metallic Pd film forms spontaneously behind the combustion front which propagates at about ˜0.3 cm s⁻¹. Different stages of the Pd film deposition on a glass substrate can be visualized and the propagation front can be clearly identified. The propagation process is analogous to the burning of a piece of paper during which cellulose oxidizes into an ash with heat and gas generation.

Morphology of the Pd film deposited on a glass substrate via aqueous solution combustion is studied by scanning and transmission electron microscopy (SEM and TEM).

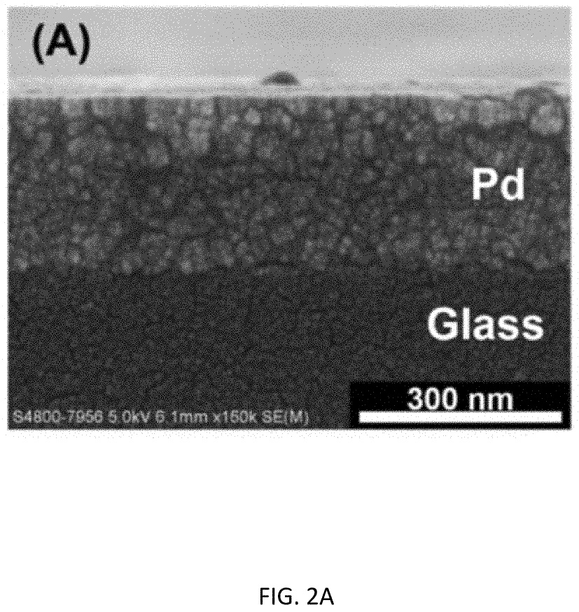

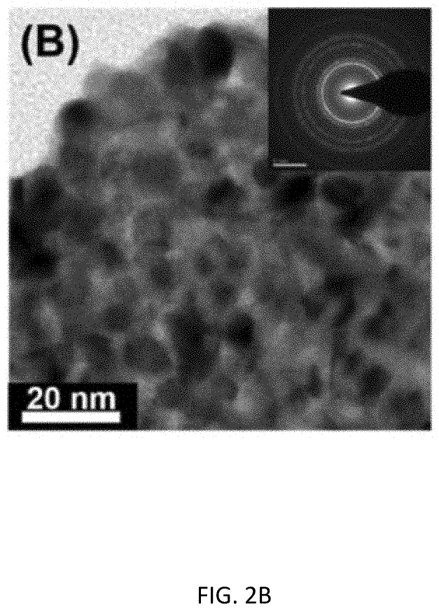

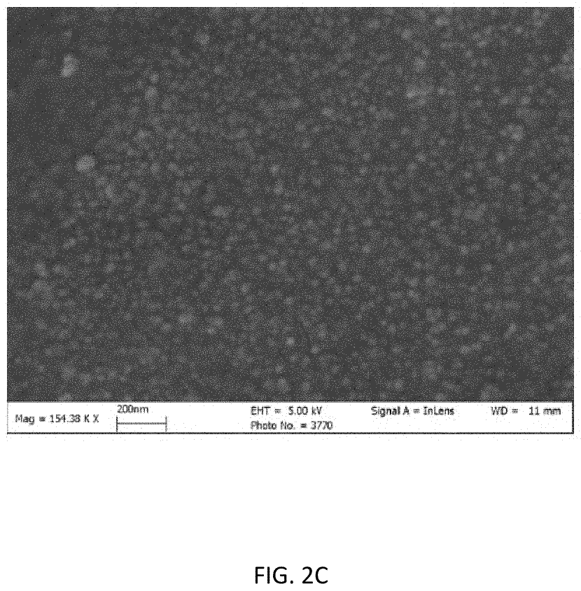

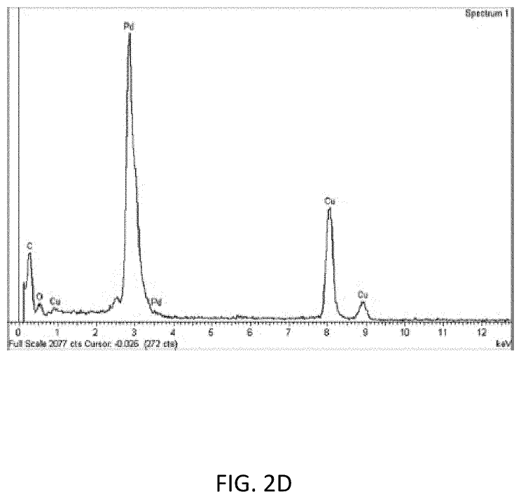

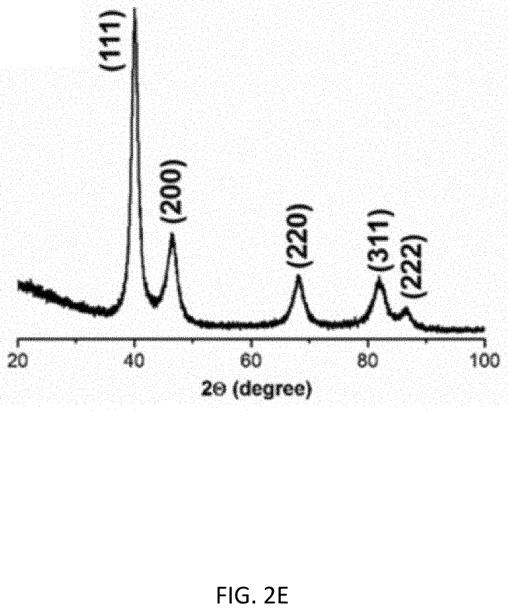

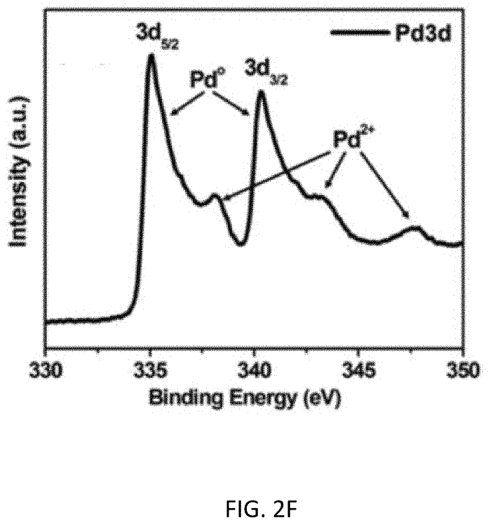

The film is uniform across the substrate, and the thickness is determined to be ˜260 nm from the SEM of a cross-sectional image shown in FIG. 2A. For thin films <200 nm thickness, the precursor solution can be spin-coated onto the substrate, and the product film thickness is readily regulated by changing the spinning rate. At rotation speeds of 2000, 3000, and 5000 rpm films with thicknesses of 60, 40, and 20 nm, respectively, were obtained as shown in the TEM image in FIG. 2B demonstrates that the film is composed of randomly oriented nanoparticles with a grain size of 5-15 nm. A top view SEM image of the Pd film surface is shown in FIG. 2C, which also confirms the polycrystalline nature of the film with granular morphology. The X-ray diffraction peaks (XRD) obtained from the deposited film can be assigned to the planes of fcc Pd (JCPDS No. 46-1043). Energy dispersive spectroscopy (EDS) indicates the presence of metallic Pd with less than 2 wt. % oxygen content (FIG. 2D).

The film is dense without any noticeable porosity. The porosity is detrimental to metal films intended for use in nano-electronic devices since pores and cavities can trap charge carriers and reduce their mobility. The adhesion of the Pd films to glass substrates was very strong, and no delamination was observed during scotch tape pull tests. The high crystallinity of nanoparticles can be seen from the sharp rings in the selected area electron diffraction (SAED) pattern and was also confirmed from XRD peaks (FIGS. 2B, 2E). The surface chemical state of the Pd in the film was analyzed by X-ray photoelectron spectroscopy (XPS) (FIG. 2F). The Pd 3d spectrum consists of two doublets centered at 335.0 and 340.3 eV assigned to metallic Pd with a consistent peak separation of 5.3 eV. The other small peaks belong to Pd²⁺ species which may arise from oxygen or water chemisorption.

The mechanism of the Pd film deposition was also considered. Syntheses of several metallic powders and alloys (e.g., Ni, Cu, and Co_{0.5}Ni_{0.5}) in the bulk via SCS method have been reported recently.[34]-[37]. Manukyan et al. [37] have explored the mechanism of SCS synthesis of metal Ni powder from a Ni(NO₃)₂—NH₂CH₂COOH mixture. Formation of NiO at ˜250° C. is observed. Metallic Ni powder can only be formed above 450° C. when NiO is reduced by gases generated in combustion reaction. Up until the present invention, no deposition of metal films via SCS has was known from the literature.

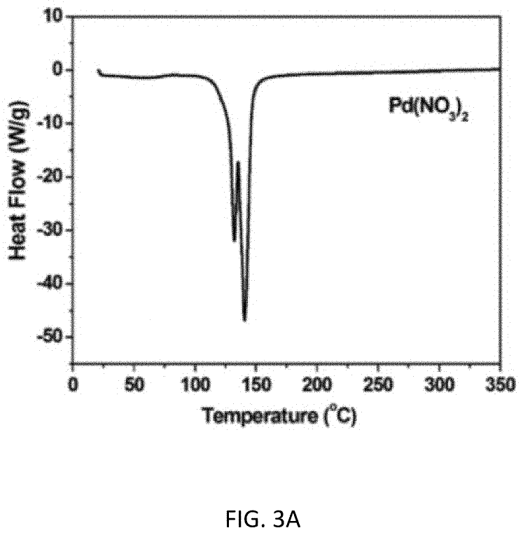

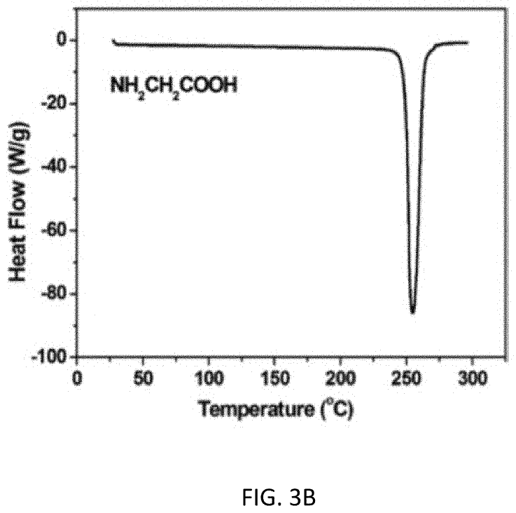

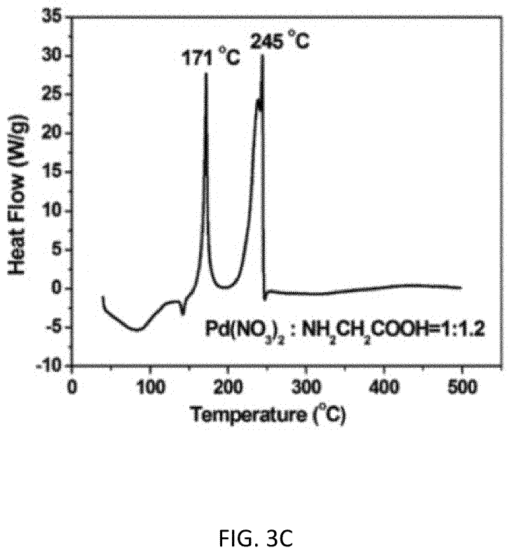

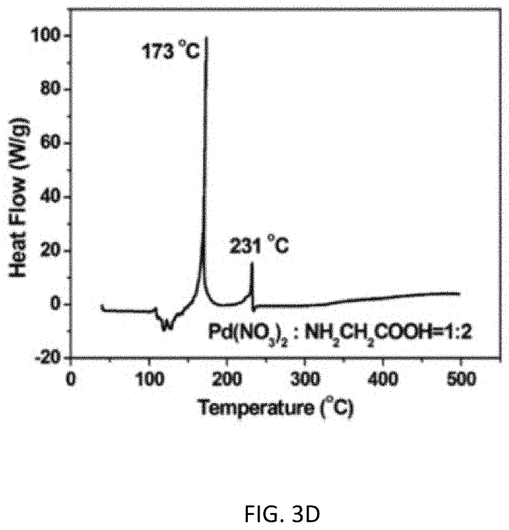

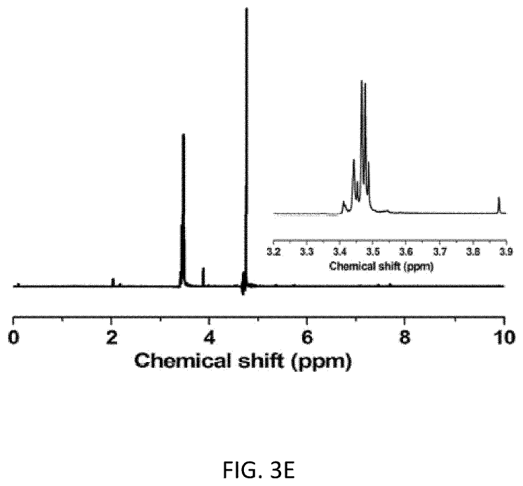

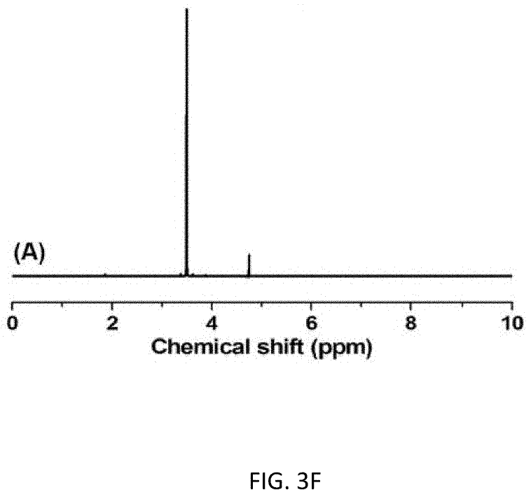

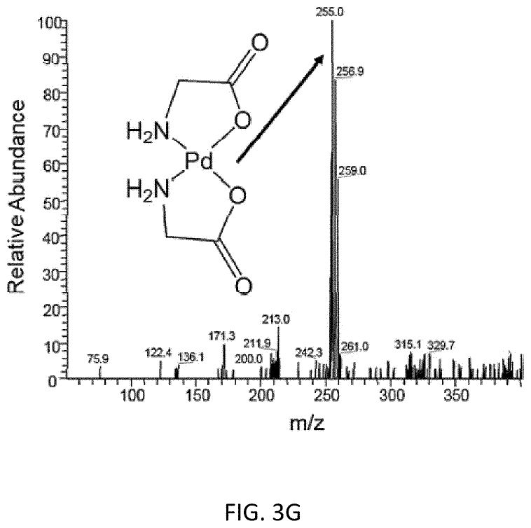

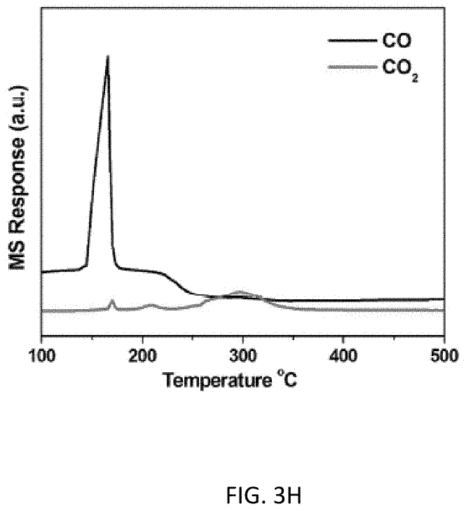

The present invention relates to the deposition of a high quality Pd film via low temperature aqueous combustion of a Pd(NO₃)₂—NH₂CH₂COOH mixture. Furthermore, the metal film is produced at temperature as low as 250° C. To understand the mechanism of metallic film formation at low temperature from Pd(NO₃)₂ and NH₂CH₂COOH, differential scanning calorimetry (DSC) experiments were conducted for four samples viz.: (A) Pd(NO₃)₂, (B) NH₂CH₂COOH, (C) 1:1.2 molar ratio mixture of Pd(NO₃)₂ and NH₂CH₂COOH, and (D) 1:2 mixture of Pd(NO₃)₂ and NH₂CH₂COOH with the results plotted in FIGS. 3A-3D.

In the control DSC experiments, decomposition of Pd(NO₃)₂ is completed before 150° C. with two overlapping endothermic peaks around 140° C. (FIG. 3A) whereas NH₂CH₂COOH decomposes endothermically around 250° C. (FIG. 3B). For the binary mixtures of Pd(NO₃)₂ and NH₂CH₂COOH, the reaction is completed below 250° C. as no further peaks are observed in the DSC scan up to 500° C. (FIGS. 3C and 3D). There are two exothermic reactions with DSC peaks located at 171° C. and 231-245° C. As suggested in the literature, [37,38] the reaction between N₂O and NH₃, which are separately formed from metal nitrate decomposition and glycine decomposition, respectively, is highly exothermic and takes place near 250° C. The temperature at which this reaction occurs, however, overlaps with the endothermic NH₂CH₂COOH decomposition, as shown in FIG. 3B. Therefore, there is a difference in height of the second peak between FIGS. 3C and 3D. The 171° C. peak in DSC scans of the Pd(NO₃)₂—NH₂CH₂COOH mixture suggests a reaction other than oxidation of NH₂CH₂COOH. Exploring the possibility of an alternative reaction, we have identified a palladium diglycinate complex which is formed below 100° C. When the 1:2 molar ratio of Pd(NO₃)₂—NH₂CH₂COOH mixed solution was heated to 80° C., and subsequently cooled to room temperature, a change in the solution color from dark brown to pale yellow was observed and confirmed the existence of a palladium(II) diglycinate complex via ¹H NMR (FIGS. 3E-3F) and electrospray-ionization mass spectrometry (ESI-MS) (FIG. 3G).

Next the formation of palladium(II) diglycinate by the complexation reaction is shown in Scheme 1:

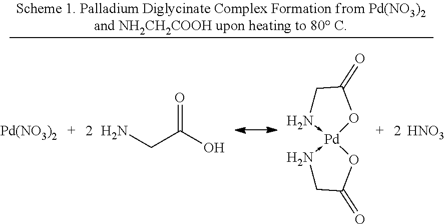

Bidentate ligands are coordinated to Pd atom through the oxygen atoms of the carboxyl groups and nitrogen atoms of amine group forming stable five-membered rings in this planar dsp2 complex. This chelate was previously synthesized and characterized in the literature. [39] However, it is important to note that the complex formation may not be completed and noncomplexed Pd(NO₃)₂ and NH₂CH₂COOH may still be present in the solution.

The gaseous products of the combustion of the Pd—(NO₃)₂:NH₂CH₂COOH=1:2 mixture were analyzed by in situ mass-spectroscopy in a Hiden CatLab instrument with a temperature scan microreactor connected to an online Qic 20 quadrupole mass spectrometer. The results in FIG. 3H revealed that the diglycinate decomposition at 170° C. to PdO was accompanied by a large amount of CO generation.

These data indicate that the amount of NH₂CH₂COOH not only influences the amount of palladium diglycinate formed but also the amount of reducing CO, and hence alters the combustion pathway. Importantly, from Pd—(NO₃)₂:NH₂CH₂COOH=1:1.2 to 1:2.5 pure Pd film can be produced at 250° C. However, when the amount of NH₂CH₂COOH increases, corresponding gas generation also increases which leads to films with higher porosity. At NH₂CH₂COOH molar ratio >2.5, there is no ignition, and only black carbonaceous deposit forms at 250° C.

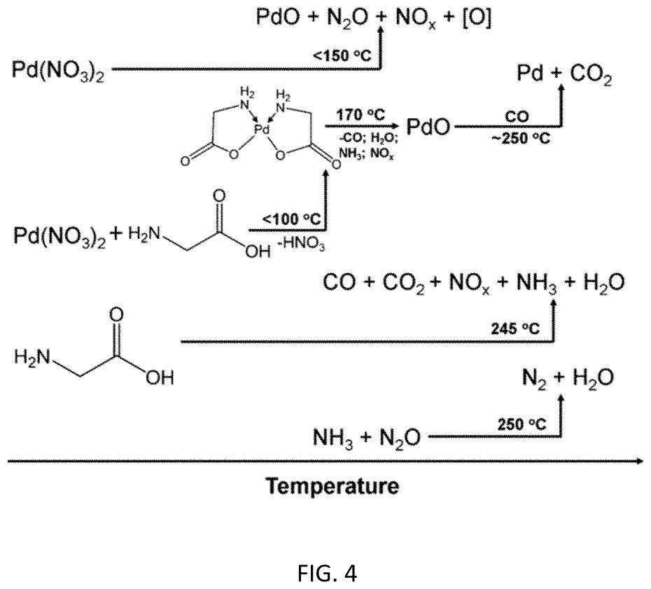

Based on these results, a reaction mechanism for Pd film formation from Pd(NO₃)₂—NH₂CH₂COOH is outlined in FIG. 4. Below 100° C. a palladium diglycinate complex is formed which then decomposes exothermically at ˜170° C. forming PdO with CO generation. The third stage around 250° C. is a combination of three possible reactions: (i) the endothermic decomposition of noncomplexed NH₂CH₂COOH (˜250° C.) as shown in FIG. 3B; (ii) highly exothermic reaction at 250° C. between N₂O generated earlier from Pd(NO₃)₂ decomposition and NH₃, which is produced from complex at ˜170° C. or glycine decomposition at ˜250° C.; and (iii) formation of Pd at 250° C., which is most likely formed by endothermic reduction of PdO by CO. Therefore, the correct interplay between these reactions must be arranged to deposit a pure and dense metal film.

The electrocatalytic properties of Pd film were determined. Electrochemical performance of the Pd film deposited by the low temperature aqueous combustion process was evaluated with oxidation of methanol, ethanol, and glycerol. Direct alcohol fuel cells (DAFCs) have drawn great attention in recent years as a possible alternative to hydrogen-fed fuel cells. [40,41] Alcohols are liquid, and hence, they have high gravimetric and volumetric energy densities for easy transportation and storage. Electrocatalytic oxidation of alcohols with higher molecular weight than methanol is of great importance as they have high energy density, low toxicity, and a high boiling point. [42,43] As acidic proton exchange membranes have high proton conductivity, the noble metal catalysts in acidic media, particularly Pt, have been used the most. However, due to a poisoning of Pt catalyst with intermediates such as carbon monoxide, acetaldehyde, and acetic acid, acidic proton exchange membranes have sluggish kinetics and overall poor fuel cell efficiency. [44] It has been demonstrated that the oxidation efficiency can be improved using alkaline media, and Pd is known to be one of the most active anode electrocatalysts for alcohol oxidation in alkaline media. [45-48]

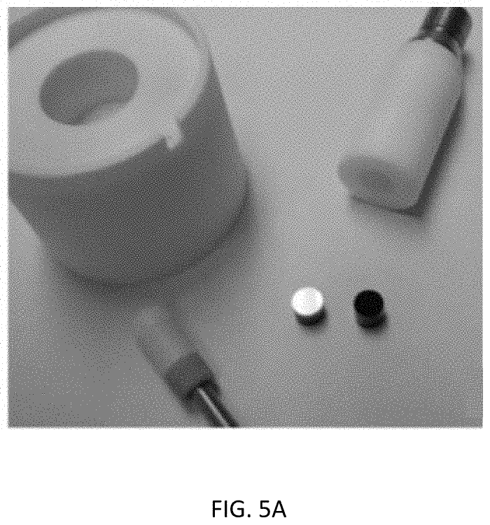

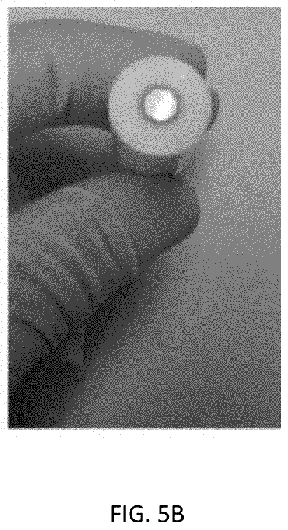

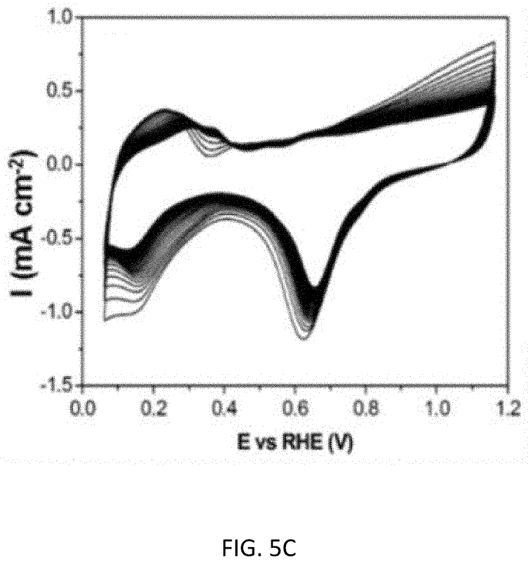

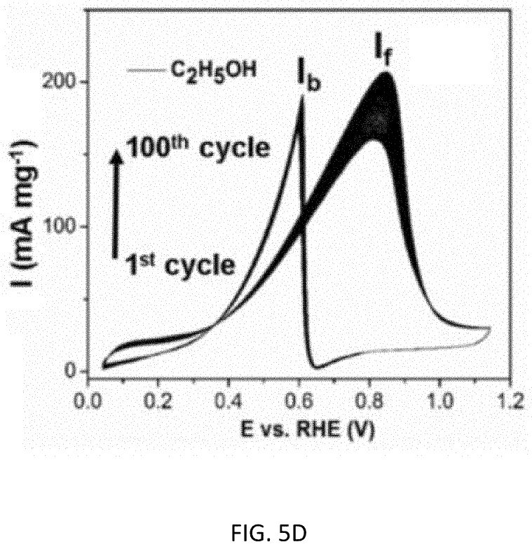

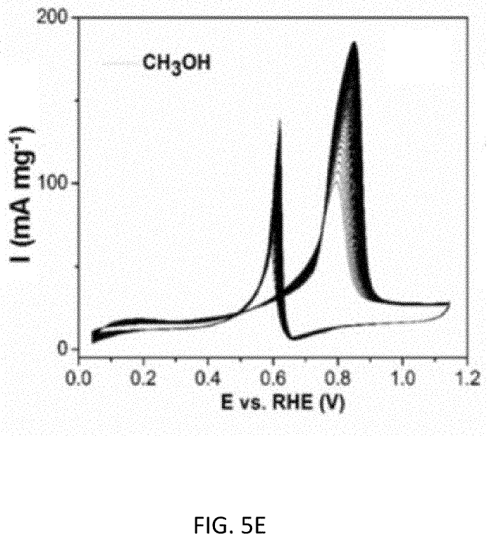

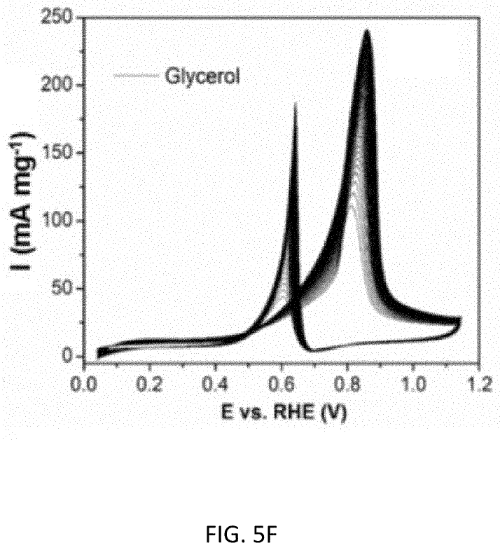

The electrocatalyst was prepared by direct deposition of a Pd film on an interchangeable glassy carbon electrode using the described low temperature aqueous solution combustion protocol at 250° C. without needing any binder or additive. Photographs of the uncoated glassy carbon electrode, Pd film coated electrode, and electrode assembled rotating disk are shown in FIGS. 5A-5B. Control cyclic voltammograms (CVs) of the catalyst coated electrodes in deaerated alkaline solution without a fuel are shown in FIG. 5C. The cathodic peaks at ˜0.6 V correspond to reduction of palladium oxide which is formed during anodic scan. The peaks at low potentials are associated with the adsorption and desorption of hydrogen on the palladium surface. The CVs of methanol, ethanol, and glycerol oxidations on the electrode with mass loading of 0.18 mg cm⁻² are displayed in FIGS. 5D-5F. All oxidation currents are normalized to the Pd mass loaded on the electrodes. The oxidation of alcohols on Pd surfaces occurs by formation of intermediates, which are oxidized on the forward and reverse scans. Onset potential (Eₒₙₛₑₜ), forward (If), and reverse peak (Ib) current densities are utilized to assess the electrocatalytic activity of catalysts. The peak current densities for ethanol and glycerol are slightly higher than that for methanol indicating that alcohols with higher molecular weight oxidize on a palladium surface more efficiently.

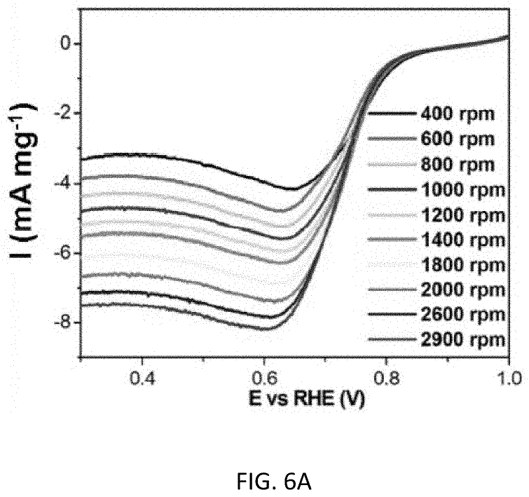

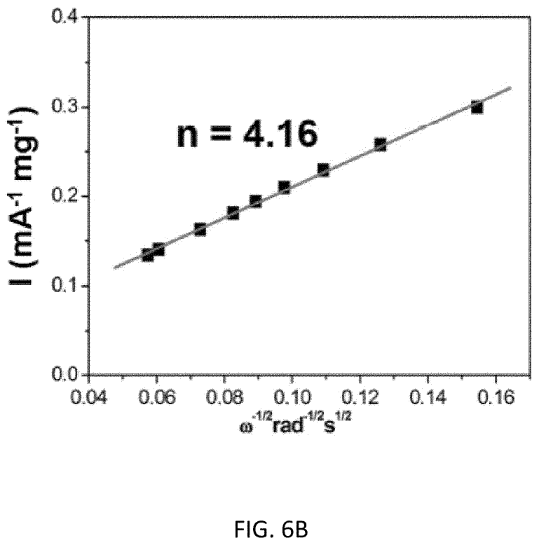

In addition, the onset potential for ethanol oxidation is located at about 0.3 V, while Eₒₙₛₑₜ for methanol and glycerol oxidation are located at around 0.5 V. The 200 mV negative shift of Eₒₙₛₑₜ indicates much better kinetics of ethanol electrooxidation compared to methanol and glycerol. After 100 cycles, the forward current peak is only shifted by 20 mV toward the higher potential for ethanol oxidation demonstrating good stability, whereas it is shifted by 40 mV for glycerol and by 69 mV for methanol. These results demonstrate that the SCS deposited Pd film showed excellent electrocatalytic performance for alcohol oxidation, specifically for ethanol. At the cathode of fuel cells, ORR has a crucial role for the high performance of fuel cells. To evaluate the activity of a prepared Pd film in ORR, rotating-disk voltammograms at different rotating rates (from 400 to 2900 rpm) in alkaline media were recorded and the data are presented in FIGS. 6A-6B. The onset potential of Pd film for ORR was at approximately 0.84 V (FIG. 6A). The four-electron pathway is consistent with earlier reports on different Pd catalysts (FIG. 6B). Considering the high scalability and ease of preparation, this method has great potential to produce high-quality Pd films for electrochemical applications. he results obtained are highly encouraging and alloying Pd with other metals may further improve its electrocatalytic activity.

The process of the present invention was applied to Suzuki-Miyaura Coupling in a Reusable “Catalytic Pd Flask.” Besides being an effective catalyst in fuel cell applications, Pd is also known to be highly active for many C—C cross-coupling reactions such as Suzuki-Miyaura, Sonogashira, Negishi, Mizoroki-Heck, and Stille have proposed the synthesis of natural products and other bioactive compounds in this way. [49, 50] Among these, room-temperature Suzuki-Miyaura coupling is of great importance, involving the reaction of aryl halides with arylboronic acids to produce biaryls. However, commonly used homogeneous palladium complexes are expensive, the ligands are air sensitive, and an additional step is required to separate the homogeneous catalyst from the product. [51] These factors are major complications for commercialization of new catalysts as stringent purity tolerances are required (<5 ppm residual metal in the product). [52] To overcome these issues, particularly the laborious separation and purification steps, several strategies have been reported to produce various ligand-free heterogeneous Pd catalysts such as carbon supported palladium nanoparticles, palladium(II) clays, hydroxyapatite supported Pd complexes, palladium clusters on copolymer micelles, and palladium on mesoporous silica. [53-55]

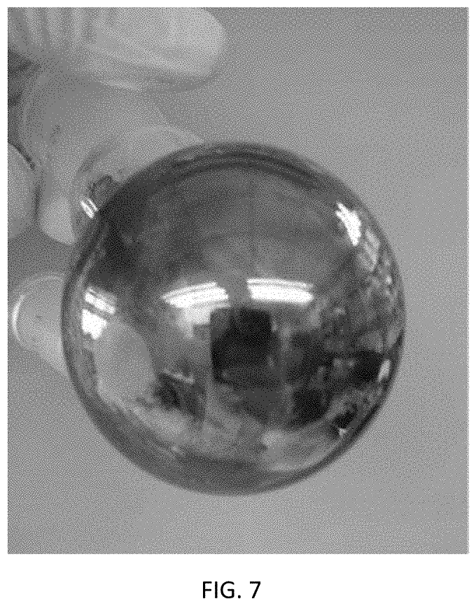

The present invention can be utilized to create a novel reusable catalytic round-bottomed flask for Suzuki-Miyaura coupling reaction. The Pd catalyst resides on the interior wall of the flask and does not need to be recovered via a separation process. To prepare the reusable round-bottomed flask, a Pd film with a thickness of ˜1.2 μm is deposited onto the inner walls of a heat-resistant borosilicate flask with good adhesion by multiple depositions using an as-developed low temperature aqueous solution combustion method. The image of the Pd catalyst coated flask is shown in FIG. 7. Importantly, in contrast to other physical and chemical deposition methods, only the specific characteristics of the solution combustion process allow for depositing of Pd films onto the inner walls of a narrow neck round-bottomed flask with good adhesion. The good adherence between the metal and the borosilicate glass is ensured by the local high temperature generation during combustion. Besides, oxide containing islands between the glass and the metal interface may be formed via atmospheric oxygen diffusion.

The catalytic activity of the flask was evaluated in the coupling reaction of phenyl iodide and phenylboronic acid, and the results are summarized in Table 1.

TABLE 1
Suzuki-Miyaura Cross-Coupling Reaction Catalyzed
by a Pd Coated Catalytic Flask^{a}

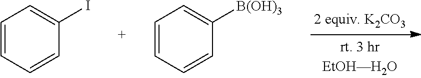

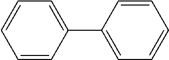 [SMILES: c1ccc(-c2ccccc2)cc1]

| cycle | yield (%) |
|---|---|
| 1 | 89 |
| 2 | 90 |
| 3 | 45 |
| 4 | 26 |

^{a}Reaction conditions: phenyl iodide (1.0 mmol), phenylboronic acid (1.2 mmol), K₂CO₃ (2.0 mmol), EtOH (2.5 mL), H₂O (2.5 mL), and Pd coating (1.5 wt %) room temperature for 3 h.

For the first two cycles biphenyl with 90% yield was achieved at room temperature within 3 h. However, after two cycles the film became brittle and peeled off from the glass surface, leading to a decrease in catalytic activity. The mechanism of heterogeneous Pd catalyzed Suzuki coupling has been debated for a long time. [56, 57] The question is whether the reaction occurring on the surface of Pd⁰ or Pd⁰ clusters can leach from the nanoparticle surface and catalyze through a leaching—redeposition mechanism. As has already been shown, for electrocatalytic reactions, the film is more stable since the reactions mainly take place on the surface of the catalyst.

Therefore, these results support the proposition that Pd film catalyzed Suzuki coupling is not purely heterogeneous and occurs through the leaching-redeposition pathway. The deactivation is probably due to redeposition of Pd⁰ clusters onto the film surface, which in turn leads to the aggregated nanoparticles having less leachable Pd⁰ clusters than before.

Besides, the leaching of Pd⁰ atoms from the film can decrease its adhesion stability to the substrate resulting in brittle films. A leaching—redeposition mechanism for Suzuki coupling was also observed for Pd nanoparticles immobilized in three-dimensional dendritic mesoporous silica nanospheres. [56] After several catalytic cycles, Pd particles were significantly enlarged due to redeposition. Although the concentration of Pd in the product was not measured after isolation, it is likely that some Pd will not redeposit back to the glass surface and remain in the solution during reaction, as another reason for activity decline in subsequent cycles. Even though Pd may be present in the product and requires a purification step, the reusable Pd flask still greatly simplifies the catalyst separation process. As opposed to conventional Pd supports such as activated carbon, silica particles, and polymer beads, there is no need to retain the mobile support particles within the reaction flask and no need to recover loose support particles during downstream purification steps. The present results show loss of activity in Suzuki coupling reaction, and the yield after the second cycle is lower than that of other reported supported Pd catalysts. [58, 59] The results are, however, preliminary, and it is believed that this invention of the reusable catalytic flask is very promising.

To improve the stability of the coating toward embrittlement, oxide supported palladium or palladium alloys instead of pure metal may be a good alternative and can be further investigated. Reactions other than Suzuki coupling can also be explored.

The present invention provides a versatile, highly scalable single step method for depositing a metallic Pd film from low temperature combustion of an aqueous solution. By using only palladium nitrate and glycine as precursors, water as a solvent, mirror-bright dense Pd films consisting of 5-15 nm particles with high crystallinity and good adhesion can be deposited at 250° C. on different substrates without subsequent annealing. Due to the unique nature of combustion process Pd films with extremely high deposition rates can be obtained, making this method an attractive alternative to sophisticated and expensive chemical or physical deposition techniques. The preparation process can be easily reproduced to deposit high-quality films on various substrates. In the mechanism of metallic Pd formation from a Pd(NO₃)₂— NH₂CH₂COOH mixture, it was revealed that a palladium diglycinate complex formed at the early stage <100° C., which alters the combustion pathway. Maintaining the delicate balance between amounts of Pd(NO₃)₂ and NH₂CH₂COOH is necessary to obtain a high-quality pure metallic film.

The effectiveness of the method and the catalytic activity of the film were tested as an electrocatalyst deposited on glassy carbon electrode without using any binder or additive. The catalyst showed excellent activity and stability for alcohol electrooxidation in alkaline media. Moreover, the method was used to implement the innovative concept of a reusable catalytic flask, which comprises a round bottomed flask with inner walls coated with palladium film, for C—C cross-coupling. The flask was tested for Suzuki-Miyaura reaction.

The protocol of the present invention is extendable to other metals and opens numerous possibilities to produce high quality pure metallic or alloy films via aqueous combustion synthesis.

### REFERENCES

The references listed below are cited throughout the specification and are identified by the corresponding number(s) placed in square brackets [ ]. Each of the following references is incorporated herein by reference in its entirety:]
[1] Heck, R. M.; Farrauto, R. J. Automobile Exhaust Catalysts. Appl. Catal., A 2001, 221, 443-457.
[2] Kim, S.-W.; Kim, M.; Lee, W. Y.; Hyeon, T. Fabrication of Hollow Palladium Spheres and their Successful Application to the Recyclable Heterogeneous Catalyst for Suzuki Coupling Reaction. J. Am. Chem. Soc. 2002, 124, 7642-7643.
[3] Wolfe, D. B.; Love, C.; Paul, K. E.; Chabinyc, M. L.; Whitesides, G. M. Fabrication of Palladium-Based Microelectronic Devices by Microcontact Printing. Appl. Phys. Lett. 2002, 80, 2222-2224.
[4] Gaudet, J. R.; de la Riva, A.; Peterson, E. J.; Bolin, T.; Datye, A. K. Improved Low-Temperature CO Oxidation Performance of Pd Supported on La-Stabilized Alumina. ACS Catal. 2013, 3, 846-855.
[5] Chen, A.; Ostrom, C. Palladium-Based Nanomaterials: Synthesis and Electrochemical Applications. Chem. Rev. 2015, 115, 11999-12044.
[6] Yamauchi, M.; Ikeda, R.; Kitagawa, H.; Takata, M. Nanosize Effects on Hydrogen Storage in Palladium. J. Phys. Chem. C 2008, 112, 3294-3299.
[7] Tittl, A.; Mai, P.; Taubert, R.; Dregely, D.; Liu, N.; Giessen, H. Palladium-Based Plasmonic Perfect Absorber in the Visible Wave-length Range and its Application to Hydrogen Sensing. Nano Lett. 2011, 11, 4366-4369.
[8] Adams, B. D.; Chen, A. The Role of Palladium in a Hydrogen Economy. Mater. Today 2011, 14, 282-289.
[9] Lim, S. H.; Radha, B.; Chan, J. Y.; Saifullah, M. S. M.; Kulkarni, G. U.; Ho, G. W. Flexible Palladium-based H2 Sensor with Fast Response and Low Leakage Detection by Nanoimprint Lithography. ACS Appl. Mater. Interfaces 2013, 5, 7274-7281.
[10] Hierso, J.-C.; Feurer, R.; Kalck, P. Platinum and Palladium Films Obtained by Low-Temperature MOCVD for the Formation of Small Particles on Divided Supports as Catalytic Materials. Chem. Mater. 2000, 12, 390-399.
[11] Yoon, S. R.; Hwang, G. H.; Cho, W. I.; Oh, I.-H.; Hong, S.-A.; Ha, H. Y. Modification of Polymer Electrolyte Membranes for DMFCs Using Pd Films Formed by Sputtering. J. Power Sources 2002, 106, 215-223.
[12] Niklewski, A.; Strunskus, T.; Witte, S.; WO11, C. Metal-Organic Chemical Vapor Deposition of Palladium: Spectroscopic Study of Cyclopentadienyl-Allyl-Palladium Deposition on a Palladium Substrate. Chem. Mater. 2005, 17, 861-868.
[13] Kumar, M. K.; Rao, M. S. R.; Ramaprabhu, S. Structural, Morphological and Hydrogen Sensing Studies on Pulsed Laser Deposited Nanostructured Palladium Thin Films. J. Phys. D: Appl. Phys. 2006, 39, 2791-2795.
[14] Lu, J.; Fu, B.; Kung, M. C.; Xiao, G.; Elam, J. W.; Kung, H. H.; Stair, P. C. Coking- and Sintering-Resistant Palladium Catalysts Achieved Through Atomic Layer Deposition. Science 2012, 335, 1205.
[15] Gharachorlou, A.; Detwiler, M. D.; Nartova, A. V.; Lei, Y.; Lu, J.; Elam, J. W.; Delgass, W. N.; Ribeiro, F. H.; Zemlyanov, D. Y. Palladium Nanoparticle Formation on TiO2(110) by Thermal Decomposition of Palladium (II) hexafluoroacetylacetonate. ACS Appl. Mater. Interfaces 2014, 6, 14702-14711.
[16] Endres, F.; Abbott, A. P.; Macfarlane, D. R. Electrodeposition from Ionic Liquids; John Wiley & Sons: New York, 2008; Ch. 4.
[17] Schaltin, S.; Brooks, N. R.; Sniekers, J.; Van Meervelt, L.; Binnemans, K.; Fransaer, J. Electrodeposition of Thick Palladium Coatings from a Palladium(II)-Containing Ionic Liquid. Chem. Commun. 2014, 50, 10248-10250.
[18] Endres, F.; Bukowski, M.; Hempelmann, R.; Natter, H. Electrodeposition of Nanocrystalline Metals and Alloys from Ionic Liquids. Angew. Chem., Int. Ed. 2003, 42, 3428-3430.
[19] Voskanyan, A. A.; Li, C. Y. V.; Chan, K.-Y.; Gao, L. Combustion Synthesis of Cr₂O₃ Octahedra with a Chromium-Containing Metal-Organic Framework as a Sacrificial Template. CrystEngComm 2015, 17, 2620-2623.
[20] Varma, A.; Mukasyan, A. S.; Rogachev, A. S.; Manukyan, K. V. Solution Combustion Synthesis of Nanoscale Materials. Chem. Rev. 2016, 116, 14493-14586.
[21] Voskanyan, A. A.; Chan, K.-Y.; Li, C. Y. V. Colloidal Solution Combustion Synthesis: Toward Mass Production of a Crystalline Uniform Mesoporous CeO2 Catalyst with Tunable Porosity. Chem. Mater. 2016, 28, 2768-2775.
[22] Nersisyan, H. H.; Lee, J. H.; Ding, J.-R.; Kim, K.-S.; Manukyan, K. V.; Mukasyan, A. S. Combustion Synthesis of Zero-, One-, Two-and Three-Dimensional Nanostructures: Current Trends and Future Perspectives. Prog. Energy Combust. Sci. 2017, 63, 79-118.
[23] Kim, M. G.; Kanatzidis, M.-G.; Facchetti, A.; Marks, T. J. Low-Temperature Fabrication of High-Performance Metal Oxide Thin-Film Electronics via Combustion Processing. Nat. Mater. 2011, 10, 382-388.
[24] Kim, M.-G.; Hennek, J. W.; Kim, H. S.; Kanatzidis, M. G.; Facchetti, A.; Marks, T. J. Delayed Ignition of Autocatalytic Combustion Precursors: Low-Temperature Nanomaterial Binder Approach to Electronically Functional Oxide Films. J. Am. Chem. Soc. 2012, 134, 11583-11593.
[25] Hennek, J. W.; Kim, M.-G.; Kanatzidis, M. G.; Facchetti, A.; Marks, T. J. Exploratory Combustion Synthesis: Amorphous Indium Yttrium Oxide for Thin-Film Transistors. J. Am. Chem. Soc. 2012, 134, 9593-9596.
[26] Rim, Y. S.; Lim, H. S.; Kim, H. J. Low-Temperature Metal-Oxide Thin-Film Transistors Formed by Directly Photopatternable and Combustible Solution Synthesis. ACS Appl. Mater. Interfaces 2013, 5, 3565-3571.
[27] Bal, S.; Cao, M.; Jin, Y.; Dai, X.; Liang, X.; Ye, Z.; Li, M.; Cheng, J.; Xiao, X.; Wu, Z.; Xia, Z.; Sun, B.; Wang, E.; Mo, Y.; Gao, F.; Zhang, F. Low-Temperature Combustion-Synthesized Nickel Oxide as Hole-Transport Interlayers for Solution-Processed Optoelectronic Devices. Adv. Energy, Mater. 2014, 4, 1301460.
[28] Kim, S. J.; Song, A. R.; Lee, S. S.; Nahm, S.; Choi, Y.; Chung, K.-B.; Jeong, S. Independent Chemical/Physical Role of Combustive Exothermic Heat in Solution-Processed Metal Oxide Semiconductors for Thin-Film Transistors. J. Mater. Chem. C 2015, 3, 1457-1462.
[29] Kang, Y. H.; Jang, K.-S.; Lee, C.; Cho, S. Y. Facile Preparation of Highly Conductive Metal Oxides by Self-Combustion for Solution-Processed Thermoelectric Generators. ACS Appl. Mater. Interfaces 2016, 8, 5216-5223.
[30] Tue, P. T.; Inoue, S.; Takamura, Y.; Shimoda, T. Combustion Synthesized Indium-Tin-Oxide (ITO) Thin Film for Source/Drain Electrodes in All Solution-Processed Oxide Thin-Film Transistors. Appl. Phys. A: Mater. Sci. Process. 2016, 122, 623.
[31] Sanchez-Rodriguez, D.; Farjas, J.; Roura, P.; Ricart, S.; Mestres, N.; Obradors, X.; Puig, T. Thermal Analysis for Low Temperature Synthesis of Oxide Thin Films from Chemical Solutions. J. Phys. Chem. C 2013, 117, 20133-20138.
[32] Marchal, W.; De Dobbelaere, C.; Kesters, J.; Bonneux, G.; Vandenbergh, J.; Damm, H.; Junkers, T.; Maes, W.; D'Haen, J.; Van Bael, M. K.; Hardy, A. Combustion Deposition of MoO3 Films: from Fundamentals to OPV Applications. RSC Adv. 2015, 5, 91349-91362.
[33] Leong, W. L.; Ren, Y.; Seng, H. L.; Huang, Z.; Chiam, S. Y.; Dodabalapur, A. Efficient Polymer Solar Cells Enabled by Low Temperature Processed Ternary Metal Oxide as Electron Transport Interlayer with Large Stoichiometry Window. ACS Appl. Mater. Interfaces 2015, 7, 11099-11106.
[34] Jiang, Y.; Yang, S.; Hua, Z.; Huang, H. Sol-Gel Autocombustion Synthesis of Metals and Metal Alloys. Angew. Chem., Int. Ed. 2009, 48, 8529-8531.
[35] Manukyan, K. V.; Cross, A.; Rouvimov, S.; Miller, J.; Mukasyan, A. S.; Wolf, E. E. Low Temperature Decomposition of Hydrous Hydrazine over FeNi/Cu Nanoparticles. Appl. Catal., A 2014, 476, 47-53.
[36] Trusov, G. V.; Tarasov, A. B.; Goodilin, E. A.; Rogachev, A. S.; Roslyakov, S. I.; Rouvimov, S.; Podbolotov, K. B.; Mukasyan, A. S. Spray Solution Combustion Synthesis of Metallic Hollow Micro-spheres. J. Phys. Chem. C 2016, 120, 7165-7171.
[37] Manukyan, K. V.; Cross, A.; Roslyakov, S.; Rouvimov, S.; Rogachev, A. S.; Wolf, E. E.; Mukasyan, A. S. Solution Sombustion Synthesis of Nano-Crystalline Metallic Materials: Mechanistic Studies. J. Phys. Chem. C 2013, 117, 24417-24427.
[38] Kondratenko, V. A.; Baerns, M. Mechanistic Insights into the Formation of N2O and N2 in NO Reduction by NH₃ over a Polycrystalline Platinum Catalyst. Appl. Catal., B 2007, 70, 111-118.
[39] Hobart, D. B.; Berg, M. A. G.; Merola, J. S. Bis-Glycinato Complexes of Palladium(II): Synthesis, Structural Determination, and Hydrogen Bonding Interactions. Inorg. Chim. Acta 2014, 423, 21-30.
[40] Lamy, C.; Lima, A.; LeRhun, A.; Delime, F.; Coutanceau, C.; Leger, J.-M. Recent Advances in the Development of Direct Alcohol Fuel Cells (DAFC). J. Power Sources 2002, 105, 283-296.
[41] Xu, C.; Shen, P. K.; Liu, Y. Ethanol Electrooxidation on Pt/C and Pd/C Catalysts Promoted with Oxide. J. Power Sources 2007, 164, 527-531.
[42] Marchionni, A.; Bevilacqua, M.; Bianchini, C.; Chen, Y.-X.; Filippi, J.; Fornasiero, P.; Lavacchi, A.; Miller, H.; Wang, L.; Vizza, F. Electrooxidation of Ethylene Glycol on Pd—(Ni—Zn)/C Anodes in Direct Alcohol Fuel Cells. ChemSusChem 2013, 6, 518-528.
[43] Zalineeva, A.; Serov, A.; Padilla, M.; Martinez, U.; Artyushkova, K.; Baranton, S.; Coutanceau, C.; Atanassov, P. B. Self-Supported PdxBi Catalysts for the Electrooxidation of Glycerol in Alkaline Media. J. Am. Chem. Soc. 2014, 136, 3937-3945.
[44] Du, W.; Mackenzie, K. E.; Milano, D. F.; Deskins, A. A.; Su, D.; Teng, X. Palladium-Tin Alloyed Catalysts for the Ethanol Oxidation Reaction in an Alkaline Medium. ACS Catal. 2012, 2, 287-297.
[45] Xu, C.; Cheng, L.; Shen, P.; Liu, Y. Methanol and Ethanol Electrooxidation on Pt and Pd Supported on Carbon Microspheres in Alkaline Media. Electrochem. Commun. 2007, 9, 997-1001.
[46] Wang, H.; Xu, C.; Cheng, F.; Jiang, S. Pd Nanowire Arrays as Electrocatalyst for Ethanol Electrooxidation. Electrochem. Commun. 2007, 9, 1212-1216.
[47] Tian, N. T.; Zhou, Z.-Y.; Yu, N.-F.; Wang, L.-Y.; Sun, S.-G. Direct Electrodeposition of Tetrahexahedral Pd Nanocrystals with High-Index Facets and High Catalytic Activity for Ethanol Electro-xidation. J. Am. Chem. Soc. 2010, 132, 7580-7581.
[48] Yang, Y.-Y.; Ren, J.; Li, Q.-X.; Zhou, Z.-Y.; Sun, S.-G.; Cai, W.-B. Electrocatalysis of Ethanol on a Pd Electrode in Alkaline Media: An in Situ Attenuated Total Reflection Surface-Enhanced Infrared Absorp-tion Spectroscopy Study. ACS Catal. 2014, 4, 798-803.
[49] Littke, A. F.; Fu, G. C. Palladium-Catalyzed Coupling Reactions of Aryl Chlorides. Angew. Chem., Int. Ed. 2002, 41, 4176-4211.
[50] Chatterjee, A.; Ward, T. R. Recent Advances in the Palladium Catalyzed Suzuki-Miyaura Cross-Coupling Reaction in Water. Catal. Lett. 2016, 146, 820-840.
[51] Sun, J.; Fu, Y.; He, G.; Sun, X.; Wang, X. Green Suzuki-Miyaura Coupling Reaction Catalyzed by Palladium Nanoparticles Supported on Graphitic Carbon Nitride. Appl. Catal., B 2015, 165, 661-667.
[52] Kohler, K.; Heidenreich, R. G.; Soomro, S. S.; Prockl, S. S. Supported Palladium Catalysts for Suzuki Reactions: Structure-Property Relationships, Optimized Reaction Protocol and Control of Palladium Leaching. Adv. Synth. Catal. 2008, 350, 2930-2936.
[53] Okamoto, K.; Akiyama, R.; Yoshida, H.; Yoshida, T.; Kobayashi, S. Formation of Nanoarchitectures Including Subnanometer Palladium Clusters and Their Use as Highly Active Catalysts. J. Am. Chem. Soc. 2005, 127, 2125-2135.
[54] Maegawa, T.; Kitamura, Y.; Sako, S.; Udzu, T.; Sakurai, A.; Tanaka, A.; Kobayashi, Y.; Endo, K.; Bora, U.; Kurita, T.; Kozaki, A.; Monguchi, Y.; Sajiki, H. Heterogeneous Pd/C-Catalyzed Ligand-Free, Room Temperature, Suzuki-Miyaura Coupling Reactions in Aqueous Media. Chem.-Eur. J. 2007, 13, 5937-5943.
[55] Han, P.; Zhang, H.; Qiu, X.; Ji, X.; Gao, L. Palladium within Ionic Liquid Functionalized Mesoporous Silica SBA-15 and its Catalytic Application in Room-Temperature Suzuki Coupling Reaction. J. Mol. Catal. A: Chem. 2008, 295, 57-67.
[56] Shen, D.; Chen, L.; Yang, J.; Zhang, R.; Wei, Y.; Li, X.; Li, W.; Sun, Z.; Zhu, H.; Abdullah, A. M.; Al-Enizi, A.; Elzatahry, A. A.; Zhang, F.; Zhao, D. Ultradispersed Palladium Nanoparticles in Three-Dimensional Dendritic Mesoporous Silica Nanospheres: Toward Active and Stable Heterogeneous Catalyst. ACS Appl. Mater. Interfaces 2015, 7, 17450-17459.
[57] Fu, F.; Xiang, J.; Cheng, H.; Cheng, L.; Chong, H.; Wang, S.; Li, P.; Wei, S.; Zhu, M.; Li, Y. A Robust and Efficient Pd3 Cluster Catalyst for the Suzuki Reaction and its Odd Mechanism. ACS Catal. 2017, 7, 1860-1867.
[58] Wang, G.; Kundu, D.; Uyama, H. One-Pot Fabrication of Palladium Nanoparticles Captured in Mesoporous Polymeric Mono-liths and Their Catalytic Application in C—C Coupling Reactions. J. Colloid Interface Sci. 2015, 451, 184-188.
[59] Li, Y.; Xu, L.; Xu, B.; Mao, Z.; Xu, H.; Zhong, Y.; Zhang, L.; Wang, B.; Sui, X. Cellulose Sponge Supported Palladium Nano-particles as Recyclable Cross-Coupling Catalysts. ACS Appl. Mater. Interfaces 2017, 9, 17155-17162.

Specific features of the invention are shown in one or more of the drawings for convenience only, as each feature may be combined with other features in accordance with the invention. Alternative embodiments will be recognized by those skilled in the art and are intended to be included within the scope of the claims. Accordingly, the above description should be construed as illustrating and not limiting the scope of the invention. All such obvious changes and modifications are within the patented scope of the appended claims.

While the present invention has been particularly shown and described with reference to preferred embodiments thereof; it will be understood by those skilled in the art that various changes in form and details may be made therein without departing from the spirit and scope of the invention.

What we claim is:

1. A method for depositing a metal film on a substrate, the method comprising:
a single heating of a precursor solution coated on a substrate, wherein the precursor solution comprises at least one metal, and whereby that the single heating causes solution combustion synthesis (SCS) to take place and the at least one metal is deposited on the substrate as a metal film.

2. The method of claim 1, wherein the at least one metal is palladium (Pd).

3. The method of claim 2, wherein the precursor solution comprises palladium nitrate (Pd(NO₃)₂) and glycine (NH₂CH₂COOH) in a molar ratio in the range of 1:1.2 to 1:2.5.

4. The method of claim 1, wherein the metal film is a palladium (Pd) film and the precursor coating is formed from palladium nitrate (Pd(NO₃)₂.H₂O) and glycine (NH₂CH₂COOH) in water.

5. The method of claim 4, wherein the precursor coating is formed by dissolving 100 mg palladium nitrate (99.9%) and 40 mg glycine (98.5%) in 20 mL ultrapure water (18.2 M Ω ·cm) to obtain a solution with Pd²⁺ concentration of 0.016 M.

6. The method of claim 4, wherein the single heating is at approximately 250° C.

7. The method of claim 1, wherein the precursor solution is coated on the substrate via spin-coating.

8. The method of claim 1, wherein the metal film is a mirror-bright dense Pd film.

9. The method of claim 1, wherein the metal film is deposited on the substrate without the use of a binder or additive.

10. The method of claim 1, wherein the metal film comprises nanoparticles having sizes in the range of 5-15 nm.

11. A reusable catalytic flask comprising:
a round-bottom flask made of heat-resistant borosilicate; and
a metal film coating on the inner walls of the flask, wherein the metal film was deposited by the method of claim 1.

12. The flask of claim 11, wherein the metal film coating is a Pd film with a thickness of ˜1.2 μm.

13. A method for preparing a substrate having a metal film, the method comprising:
preparing a precursor solution comprising at least one metal;
cleaning the substrate;
applying a coating of the precursor solution to the substrate; and
a single heating of the coated substrate such that solution combustion synthesis (SCS) takes place and the at least one metal is deposited on the substrate as a metal film.

14. The method of claim 13, wherein the at least one metal is palladium (Pd).

15. The method of claim 13, wherein the step of applying comprises spin-coating the precursor coating onto the cleaned substrate.

16. The method of claim 13, wherein the single heating is at approximately 250° C.

17. The method of claim 13, wherein the precursor solution comprises palladium nitrate (Pd) and glycine in a molar ratio in the range of 1:1.2 to 1:2.5.

18. The method of claim 13, wherein the metal film is a mirror-bright dense Pd film.

19. The method of claim 13, wherein the metal film is deposited on the substrate without the use of a binder or additive.

20. The method of claim 13, wherein the metal film comprises nanoparticles having sizes in the range of 5-15 nm.
